(19) United States
(12) Patent Application Publication
(10) Pub. No.: US 2008/0056390 A1
(43) Pub. Date: Mar. 6, 2008

(54) METHOD AND SYSTEM FOR DOPPLER ESTIMATION

(75) Inventors: BRADLEY J. RAINBOLT, SUNRISE, FL (US); MICHAEL J. RUDOWICZ, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/468,043

(22) Filed: Aug. 29, 2006

(51) Int. Cl. H04K 1/10

(52) U.S. Cl. 375/260

(57) ABSTRACT

A mobile device (101) and method (200) for estimating a Doppler frequency is provided. The method can include receiving (202) a communication signal containing preambles (120) and pilots (125), identifying pilot locations (203), computing (204) an autocorrelation from the preambles and pilots, identifying (205) a zero-crossing of the autocorrelation, and calculating (206) the Doppler frequency from the zero-crossing. The autocorrelation uses a forward (410) and backward (420) computation of a preamble fading estimate and a pilot fading estimate that is averaged over a plurality of frames that is independent of pilot structure.

### FIELD OF THE INVENTION

The present invention relates to wireless communication systems and, more particularly, to methods for signal detection.

### BACKGROUND

The mobile device industry is constantly challenged in the market place for high quality, low-cost products. Moreover, demand for mobile devices that allow users to stay continually connected has also dramatically risen. Service providers and manufacturers are offering more services over more networks for keeping users connected. In order to achieve “seamless mobility”, and allowing users to stay continually connected, a mobile device must remain in constant communication with multiple base stations. In general, a mobile device is connected when the device is in a coverage area of a service provider. As the mobile device leaves the coverage area, signal strength and reception quality can deteriorate, thereby disrupting service quality.

Moreover, as users of mobile devices become more mobile, moving from one region to another, changes in coverage can affect signal quality reception and connectivity. For example, when the mobile device is in a vehicle that travels through different coverage regions, maintaining connectivity is a key concern. Users do not generally want a service disrupted during transitions from one cell site to another. In such cases, it may be useful to have an estimate of the speed of the mobile device. The speed of the mobile device can be used to assess connectivity between multiple base stations.

In one arrangement, a Doppler frequency can be estimated from a communication signal transmitted to the mobile device. The Doppler frequency can be used to determine a speed of the mobile device. The Doppler frequency can be calculated when certain pilot symbols of the communication signal are uniformly spaced. In standard communication protocols, such as a TDMA, CDMA, GSM, the pilots are uniformly spaced which allows for a straightforward calculation of the Doppler frequency. However, in Time-Division Duplex (TDD) systems wherein the pilots are non-uniformly spaced, standard methods cannot be employed to calculate the Doppler frequency. As one example, in the TDD mode of IEEE 802.16, the pilot spacing may change during a communication session thereby complicating the calculation of the Doppler frequency. Furthermore, in Orthogonal Frequency Division Multiplexing (OFDM) systems having irregular pilot structures, estimating the Doppler frequency is particularly challenging as a result of irregular pilot spacing.

### SUMMARY

Broadly stated, embodiments of the invention are directed to a mobile device and method for calculating a Doppler frequency. The method can include receiving a communication signal containing preambles and pilots, computing an autocorrelation from the preambles and pilots, identifying a zero-crossing of the autocorrelation, and calculating the Doppler frequency from the zero-crossing. The autocorrelation can use a product of a preamble fading estimate and a pilot fading estimate that is averaged over a plurality of frames. The calculation of the fading estimate may be independent of pilot structure. The autocorrelation can include a forward calculation and backward calculation. Forward values of the autocorrelation can be computed using preambles and pilots of a current frame of the communication signal. Backward values can be computed using preambles of the current frame of the communication signal and pilots of a previous frame of the communication signal.

In one aspect, the method of computing forward and backward values over a plurality of frames allows for the generating of the autocorrelation from a communication signal having irregularly spaced pilot symbols that change over time. In one implementation, a location of the changing pilot symbols in one or more zones of the communication signal can be determined on a frame-by-frame basis to allow zone independent Doppler frequency estimation. The method of computing the backward values can include determining whether a symbol falls within a forward range corresponding to a downlink portion of a current frame, or a backward range corresponding to a downlink portion of a previous frame. The forward and backward calculations of the pilots can increase a detection range of the Doppler frequency.

One application for using the Doppler frequency is directed to noise reduction in channel estimation. In the process of channel equalization, received pilot symbol estimates are generally noisy. The Doppler frequency can be used to determine a length of a pilot symbol filter. As the user velocity is increased, the pilot symbol filtering window length can be reduced. As the user velocity decreases, the pilot symbol filtering window length can be increased. The method can further include averaging or filtering the pilot symbols using the pilot symbol filter to reduce noise on the pilots.

Another application for using the Doppler frequency is updating a hand-over to one or more base stations. The method can include estimating a speed from the Doppler frequency, monitoring a signal strength a plurality of base stations, and handing over to one or more base stations based on the speed and signal strength. The monitoring of the signal strength can change in accordance with the speed. If the speed is within a lower range, the autocorrelation can be computed using only the preambles. If the speed is within a higher range, the autocorrelation can be computed using both the preambles and pilots. Computing the autocorrelation from only the preambles provides a low frequency range for detecting the Doppler frequency. Computing the autocorrelation from the preambles plus pilots provides a high frequency range for detecting the Doppler frequency. Accordingly, the autocorrelation can be computed using both the preambles and the pilots for higher speeds, and the preambles only for lower speeds.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a mobile communication system in accordance with the embodiments of the invention;

FIG. 2 is a frame containing a downlink portion and an uplink portion in accordance with the embodiments of the invention;

FIG. 3 is time and frequency representation of the frame of FIG. 2 in accordance with the embodiments of the invention;

FIG. 4 is a diagram of a frame containing a preamble and pilots in one or more zones in accordance with the embodiments of the invention;

FIG. 5 is a block diagram of a mobile device for estimating a doppler frequency in accordance with the embodiments of the invention;

FIG. 6 is a method for estimating a doppler frequency in accordance with the embodiments of the invention;

FIG. 7 is a plot of an autocorrelation identifying a zero-crossing in accordance with the embodiments of the invention;

FIG. 8 is a method for computing a fading estimate using only preambles in accordance with the embodiments of the invention;

FIG. 9 is an illustration for computing fading estimates from preambles of multiple frames in accordance with the embodiments of the invention.

FIG. 10 is a plot for estimating a low or high Doppler frequency in accordance with the embodiments of the invention;

FIG. 11 is a method for computing a fading estimate using preambles-plus-pilots in accordance with the embodiments of the invention;

FIG. 12 is a method for computing forward values of an autocorrelation in accordance with the embodiments of the invention;

FIG. 13 continues the method of FIG. 12 for computing forward values of an autocorrelation in accordance with the embodiments of the invention;

FIG. 14 is an illustration for computing autocorrelation values in accordance with the embodiments of the invention;

FIG. 15 is a plot for a first subcarrier containing uniformly spaced pilots and a second subcarrier containing irregularly spaced pilots in accordance with the embodiments of the invention;

FIG. 16 is a method for computing backward values of an autocorrelation in accordance with the embodiments of the invention;

FIG. 17 is an illustration for identifying forward or backward computations of the autocorrelation in accordance with the embodiments of the invention;

FIG. 18 is an illustration for computing forward and backward values in a plurality of frames using the preambles-plus-pilots method in accordance with the embodiments of the invention;

FIG. 19 is an illustration for combining autocorrelation values in accordance with the embodiments of the invention;

FIG. 20 is a plot for estimating a low or high Doppler frequency in accordance with the embodiments of the invention;

FIG. 21, is an illustration for updating handover to a base station in view of a speed based on Doppler frequency; and

FIG. 22, is a method of employing Doppler frequency to noise reduction in channel estimation.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention are directed to a method and mobile device for estimating a Doppler frequency. In particular, the method can use a preambles only method and a preambles-plus-pilots method for estimating an autocorrelation. An autocorrelation for the preambles and pilots method can be computed from a forward and backward computation of fading estimates which can be computed in parallel. The preambles-only method, is designed for lower speeds, and the autocorrelation is computed at multiples of a frame period T_{frame}. The Preambles-plus-pilots method, is designed for higher speeds, and the autocorrelation is computed at several values within a compressed range of (0,T_{frame}). Notably, calculating the autocorrelation is a novel aspect of one embodiment of the invention. Upon generating the autocorrelation in accordance with the embodiments of the invention, a zero crossing can be identified from the autocorrelation for determining the Doppler frequency as is known in the art.

The computation of forward and backward values for the Preambles-plus-pilots method uses a product of a preamble fading estimate and a pilot fading estimate that is averaged over a plurality of frames and is independent of pilot structure. The preambles-plus-pilots method mitigates issues associated with estimating autocorrelations from irregular pilot structures in a Time-Division Duplex (TDD) system. The Preambles-plus-pilots method can be completely zone-independent, and employed for any number of zones of any type, with no restriction on where within the frame the zones begin and end. Furthermore, the setup of zones can change from frame to frame, in any manner. The Preambles-plus-pilots method can mitigate complications introduced by zone-switching.

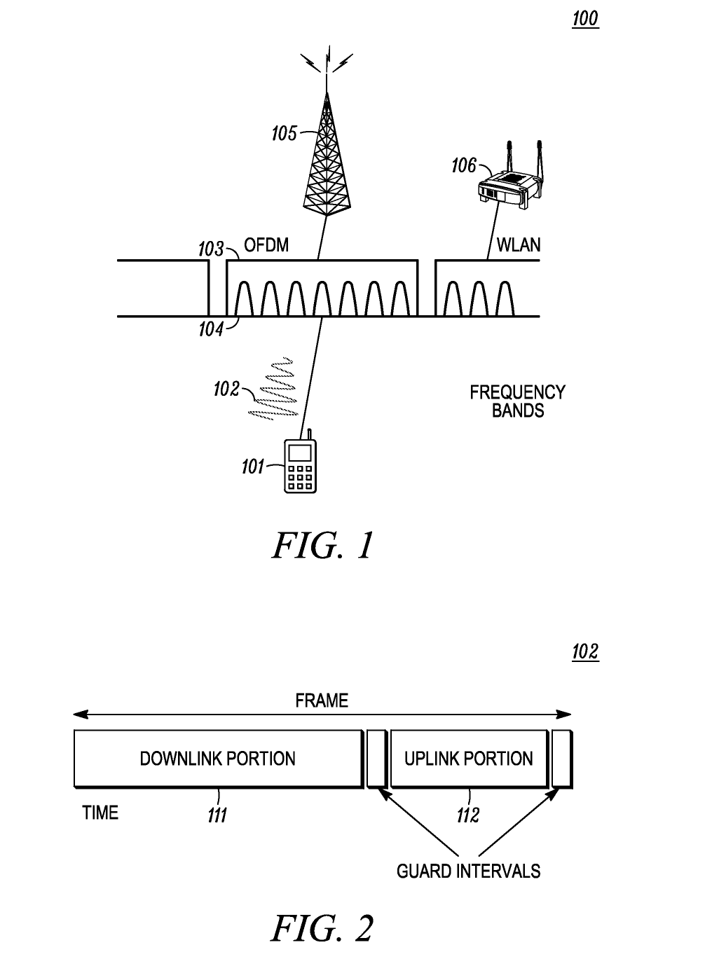

Referring to FIG. 1, a mobile communication system 100 for providing wireless connectivity is shown. The mobile communication system 100 can include at least one mobile device 101 and at least on base station 105. Understandably, more than one base station 105 and more than one mobile device 101 can be included in the mobile communication system 100. The mobile communication system 100 can provide wireless connectivity over a radio frequency (RF) communication network such as a base station 105. The base station 105 may also be a base receiver, a central office, a network server, or any other suitable communication device or system for communicating with the one or more mobile devices. The mobile device 101 can communicate with one or more cellular towers 105 using a standard communication protocol such as Time Division Multiple Access (TDMA), Global Systems Mobile (GSM), integrated Dispatch Enhanced Network (iDEN), Code Division Multiple Access (CDMA), Orthogonal Frequency Division Multiplexing (OFDM) or any other suitable modulation protocol. The base station 105 can be part of a cellular infrastructure or a radio infrastructure containing standard telecommunication equipment as is known in the art. In one arrangement, the mobile device 101 can communicate with the base station 105 using a physical layer such as Orthogonal Frequency Division Multiplexing (OFDM). OFDMA achieves high throughput over a time-dispersive radio channel, without the need for a channel equalizer in a receiver of the mobile device 101. The mobile device 101 and the base receiver 105 can also communicate over CDMA, GSM, or iDEN, and are not limited to OFDM.

In another arrangement, the mobile device 101 may also communicate over a wireless local area network (WLAN). For example the mobile device 101 may communicate with a router 106, or an access point (not shown), for providing packet data communication. In a typical WLAN implementation, the physical layer can use a variety of technologies such as 802.11b, 802.11g, IEEE 802.16, or any other Wireless Local Area Network (WLAN) technologies. As an example, the physical layer may use infrared, frequency hopping spread spectrum in the 2.4 GHz Band, or direct sequence spread spectrum in the 2.4 GHz Band, or any other suitable communication technology, and is not limited to this frequency.

The mobile device 101 can receive communication signals from either the base station 105 or the router 106. Other telecommunication equipment can be used for providing communication, and embodiments of the invention are not limited to only those components shown. In particular, the base station 105, or the router 106, can communicate over a frequency band 103 to the mobile device 101. A CDMA, OFDM, WLAN, or WiMAX system may transmit information over the frequency band 103 to the mobile device. Frequency bands can also include UHF and VHF for short range communication. As one example, the mobile device 101 may receive a UHF radio signal having a carrier frequency of 600 MHz, a GSM communication signal having a carrier frequency of 900 MHz, or a IEEE-802.11x WLAN signal having a carrier frequency of 2.4 GHz, but is not limited to these.

In general, the base station 105 or the router 106 will be responsible for allocating one or more frequencies 104 to the mobile device 101. Once assigned one or more frequencies 104, the mobile device 101 can communicate over the mobile communication system 100 using the one or more assigned frequencies 104. Notably, depending on the form of communication, various frequencies 104 may be available. The mobile device 101 may also have multiple transceivers to communicate simultaneously over the one or more frequencies 104. In one arrangement the mobile device 101 may include multiple transceivers to communicate simultaneously with the base station 105 and router 106 or other communication equipment.

A communication signal 102 can be transmitted between the mobile device 101 and the base station 105 for providing communication, such as a phone call, a packet data connection, or any other form of communication. The communication signal 102 can be partitioned into frames, as is known in the art. Referring to FIG. 2, in the Time-Division Duplex (TDD) mode of 802.16e, the frame can include a Downlink (base 105 to mobile 101) portion 111 and an Uplink (mobile 101 to base 105) portion 112 each containing data traffic as shown. In IEEE 802.16e, the downlink portion 111 and the uplink portion 112 are transmitted in the same frequency band. Data traffic between mobile 101 and base station 105 is generally asymmetric. Accordingly, the frame is generally divided so that the Downlink portion 111 is longer than the Uplink portion 112. For example, in IEEE 802.16e a 70/30 split may be common in practice. In IEEE 802.16e, the Downlink portion is always sent in the first part of the frame, and two small guard intervals allow for switching between transmit and receive.

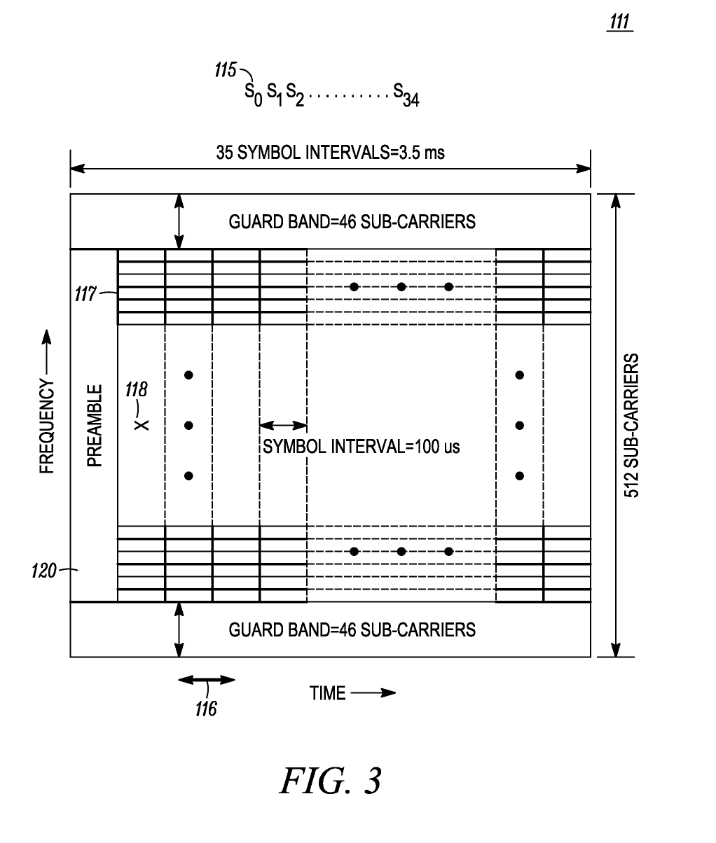

Referring to FIG. 3, the downlink portion 111 includes a plurality of symbols 115, wherein each symbol 115 represents multiple constellation points. A “symbol” can be defined as time domain signal representing a collection of “data symbols” grouped together across one or more subcarriers in the frequency domain. For example, the downlink portion 111 is divided into symbol intervals 116 in the time domain, and sub-carriers 117 in the frequency domain. Each sub-carrier 117 contains a data symbol 118. In OFDM modulation, the signal transmitted in a symbol interval 116 is formed with the IFFT of the all data symbols 118 in all the subcarriers 117 in that time interval 116. As a result of the IFFT, each data symbol 118 has an association with each sub-carrier 117. Notably, a data symbol 118 is carried by a subcarrier 117 in the frequency domain, and a symbol 115 having a symbol time interval 116 is represented in the time domain. In practice, the first symbol, S₀ (115), in the downlink 111 is devoted to the preamble 120, used for synchronization and channel estimation, in which a known sequence is transmitted. There is also a guard band in the frequency domain, which means a group of sub-carriers at the edges of the band will not be used.

Typical parameters for IEEE 802.16 are used in the foregoing, and, as shown in FIG. 3. A frame time of 5 ms for the communication signal (102 See FIG. 1) is used. That is, based on a time sliced system, a communication signal can include a plurality of frames for sending data. Each frame can convey a plurality of symbols which are transmitted or received during a symbol interval. A symbol interval of 100 us corresponds to identifier 116 in FIG. 2. That is each 5 ms frame is divided into 100 us time slots. For each frame, 35 downlink symbols (115) and 14 Uplink symbols are presented in a 70/30 split. Each symbol (downlink or uplink) is send with a duration corresponding to the symbol interval. Accordingly, for a 5 ms frame length, 3.5 ms correspond to data symbols, 1.4 ms corresponds to uplink symbols, and 0.6 ms corresponds to guard intervals of approximately 30 us each. Within each symbol there are 512 sub-carriers (117) with 46 sub-carriers of guard bands on each side. The sub-carrier spacing is 11.2 kHz. The IEEE 802.16 values are merely presented for practicing one embodiment of the invention. Other parameters and values can be employed for practicing embodiments of the invention, and are not limited to those herein.

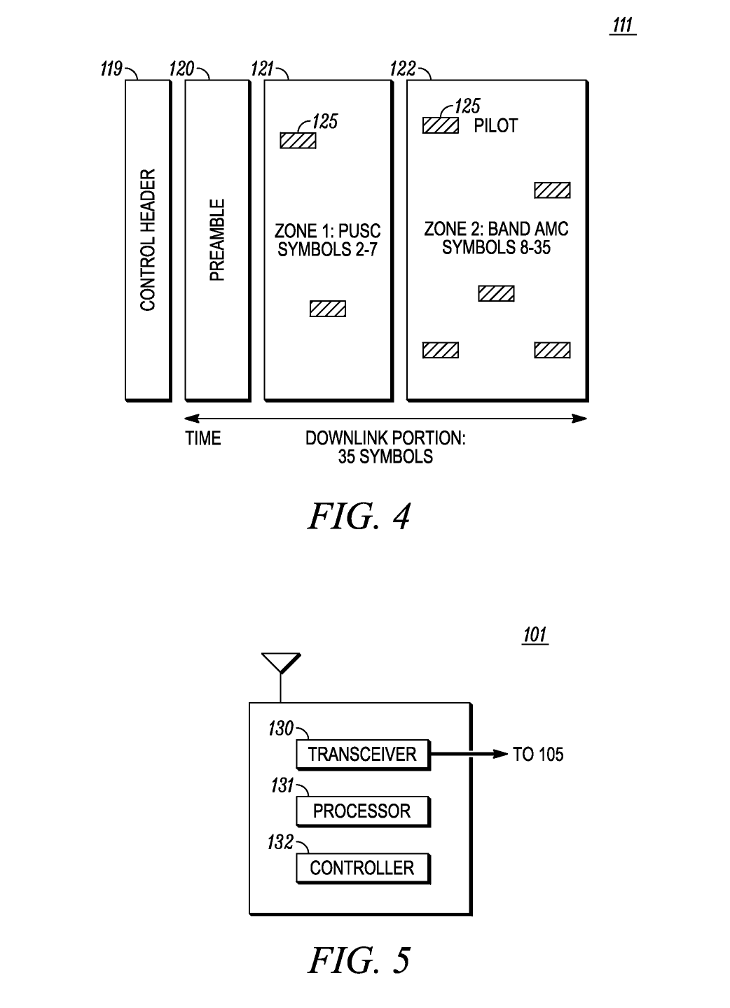

Referring to FIG. 4, the downlink 111 portion can be further divided into one or more zones (121 and 122), with several data symbols transmitted in each zone. The preamble 120 is also included in the downlink portion 111. Notably, the downlink 111 portion can include more zones than those shown in FIG. 4. Several zone types are defined in the 802.16e protocol, for example Full Usage of Sub-channels (FUSC), Partial Usage of Sub-channels (PUSC), Band Adaptive Modulation and Coding (BAMC). Each zone (121 and 122) may have a plurality of pilots 125 dispersed throughout the zone. During transmissions of data symbols 118 (see FIG. 3), known pilots 125 are transmitted at pre-determined locations to assist in channel estimation. The pilots 125 are known data symbols that can be compared to a received data symbol to estimate a channel condition. The downlink portion 111 can also include a control header 119 for identifying the locations of the pilots 125.

The pilots 125 can be used to estimate a magnitude and phase of a fading. A fade occurs when a signal strength of the communication signal 102 (See FIG. 1) deteriorates due to channel conditions. The channel conditions can introduce amplitude and phase shifts into the communication signal thereby lowering signal reception quality. It should be noted that each zone has a different structure of pilot locations. For example, zone 121 may have pilots 125 spaced in a first configuration, and zone 122 may have pilots 125 spaced in a second configuration. The pilot structures of zone 121 and zone 122 may change on a frame-by-frame basis. That is, the formatting of the pilots in each zone may differ in spacing over time. Moreover, the pilot structure can be controlled or designed into the communication system. Accordingly, estimating a channel fading can be challenging as a result of the changing pilot locations (i.e., pilot structure).

Referring to FIG. 5, a schematic of the mobile device 101 is shown. Briefly, the mobile device 101 can estimate channel fading conditions independent of pilot structure. The mobile device 101 can then use the estimate of the channel fading to generate an autocorrelation and determine the Doppler frequency. The mobile device 101 can be a radio, a cell phone, a personal digital assistant, a mobile communication device, a public safety radio, a portable media player, an emergency communication device, or any other suitable communication device. The mobile device 101 can include a transceiver 130 for receiving a communication signal, and a processor for calculating a Doppler frequency from the communication signal. The mobile device 101 can further include a controller 132 for estimating a speed of the mobile device 101 from the Doppler frequency. The mobile device 101 is not limited to the components shown and can include more than those shown. Understandably, the mobile device may include other functions or features for providing communications as is known in the art.

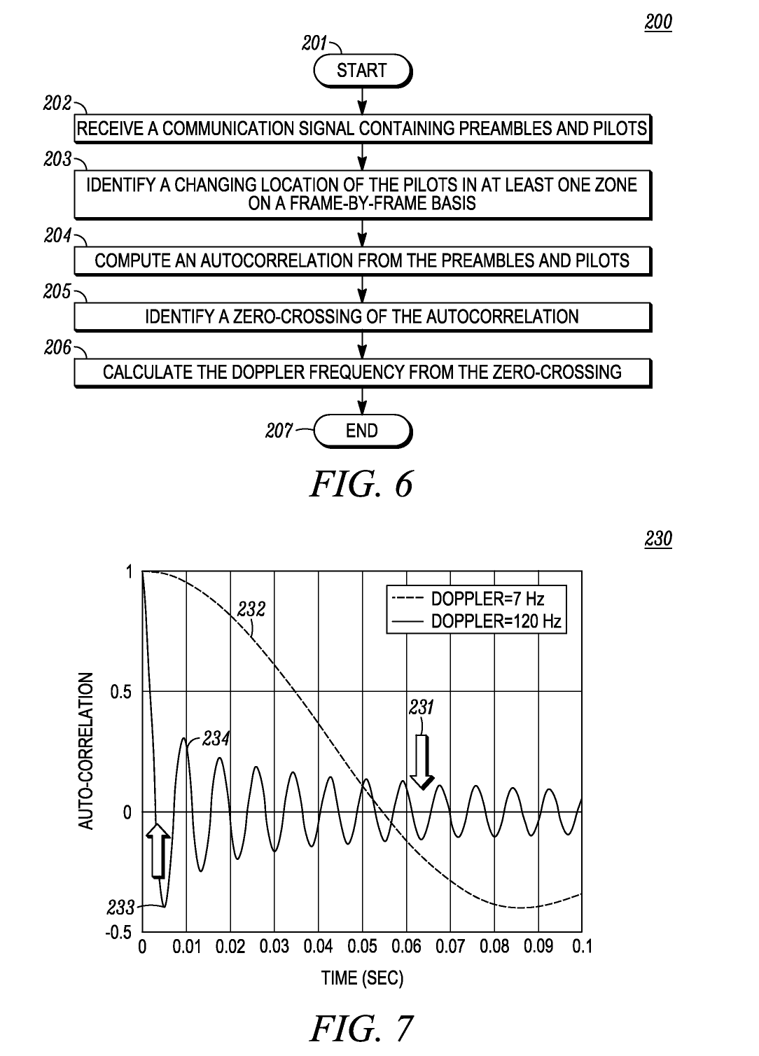

Referring to FIG. 6, a method 200 for estimating a Doppler frequency is shown. The method 200 can be practiced with more or less than the number of steps shown. To describe the method 200, reference will be made to FIGS. 1-5 and 7 although it is understood that the method 200 can be implemented in any other suitable device or system using other suitable components. Moreover, the method 200 is not limited to the order in which the steps are listed in the method 200.

At step 201, the method 200 can begin. As one example, the method 200 can be practiced by a mobile device that is stationary or moving. At step 202, a communication signal containing preambles and pilots can be received. For example, referring back to FIG. 1, the mobile device 101 can receive the communication signal 102 from the base station 105. The communication signal 102 can contain a preamble 120 and one or more pilots 125 in a downlink portion 111 as shown in FIG. 3. Specifically, in the TDD mode of IEEE 802.16, the pilots 125 are located in irregularly spaced intervals throughout one or more zones 121 and 122 (See FIG. 2).

At step 203, a changing location of the pilots within a received downlink portion of a frame can be identified. For example, referring back to FIG. 5, the processor 131 can decode a control information header 119 (See FIG. 4) in the communication signal, and determine a location of the pilots in the irregularly spaced intervals in the at least one zone of the downlink portion from the control information header.

At step 204, an autocorrelation can be computed from the preambles plus pilots. The autocorrelation uses a product of a preamble fading estimate and a pilot fading estimate that is averaged over a plurality of frames, and which is independent of pilot structure. Briefly, the processor 131 (See FIG. 5) uses knowledge of the pilot 125 (See FIG. 3) locations to calculate an autocorrelation from a plurality of channel fading estimates. The fading estimates reveal amplitude and phase distortions in the communication signal 102 (See FIG. 1) due to multi-path conditions. For example, in the classical model of a multi-path channel, many copies of the transmitted communication signal (102) arrive at a receive antenna of the mobile device 101, as a result of obstacles in the environment. Each copy arrives with a different amplitude, phase, and delay. The composite effect of the multi-path channel on the received communication signal (102) can be modeled as

r(t)=H(t)s(t)+n(t) (1)

where H(t) is a complex Gaussian random process. The fading process H(t) puts Rayleigh fading on the amplitude of the signal and gives a uniform random phase shift.

The fading process H(t) also changes with time as a result of relative motion between the transmitter and receiver. As one example, if the mobile device is in a vehicle that is moving, the fading process can undergo a Doppler shift. That is, the channel fading estimate changes in time as a function of the speed of the moving vehicle. The change of the channel estimate over time can be determined by calculating an autocorrelation of the channel fading estimate and evaluating a time shift. The Doppler frequency can be determined from the time shift. The Doppler frequency can then be used, in turn, to estimate a speed of the vehicle. For example, if the Doppler shift on the communication signal is estimated to be f_{d}, and the communication signal includes a carrier frequency f_{c} in Hz, the mobile device in a vehicle traveling at speed v in meters/sec can be given by

$$v = {f}_{d} \cdot \frac{c}{{f}_{c}} \qquad ( 2 )$$

It should be noted that the autocorrelation, R(τ), of the fading process, H(t), can be evaluated to identify a Doppler frequency of the communication signal. The autocorrelation of the fading process can be given by

R(τ)=E [H(t)H*(t+τ)]=J₀(2πf_{d}τ) (3)

where J₀ ( ) is the Bessel function of order 0. The autocorrelation involves an expectation of a product of time shifted fading estimates. Notably, the autocorrelation can be simplified to a Bessel function when an estimate of the Doppler frequency is available. It can also be seen, the argument of the Bessel function contains the Doppler frequency. Accordingly, the Doppler frequency can be determined by comparing autocorrelations to Bessel functions, and choosing a Bessel function that most closely matches, in a least squared error sense, the autocorrelation. Upon selecting the closest matching Bessel function, the Doppler frequency can be identified.

At step 205, a zero-crossing of the autocorrelation can be identified as is known in the art. Briefly, a zero-crossing of the Bessel function reveals the Doppler frequency as is known in the art. For example, as seen in EQ 3, when the autocorrelation, R(τ) equals 0, the argument of the Bessel function is the Doppler frequency. Accordingly, by identifying a zero-crossing in the autocorrelation, the Doppler frequency can be determined from the Bessel function. It should also be noted that the Bessel function has a one-to-one mapping of the zero-crossing to the Doppler frequency. That is, a zero-crossing, τ_{ZC}, of the autocorrelation corresponds with a zero-crossing of a Bessel function. Accordingly, only a zero-crossing of the autocorrelation is needed to identify the Doppler frequency.

For example, briefly referring to FIG. 7, an exemplary autocorrelation R(τ) 230 is shown. The first zero-crossing of the autocorrelation 230 can be evaluated to determine the Doppler shift. The zero-crossing τ_{ZC} identifies the argument of EQ (4) for determining the Doppler frequency. The Doppler frequency can then be used in EQ (3) to calculate the velocity (e.g. speed). As an example, the first zero-crossing 231 for a moving vehicle having a Doppler frequency of 7 Hz (232) corresponds to a velocity of 3 km/h. As another example, the first zero-crossing 233 for a moving vehicle having a Doppler frequency of 120 Hz (234) corresponds to a velocity of 50 km/h. Notably, the Doppler frequency increases as the velocity increases.

Returning back to FIG. 5, at step 206, the Doppler frequency can be calculated from the zero-crossing. For purposes of computational simplicity, a zero-crossing, τ_{ZC}, of the autocorrelation can determine the Doppler frequency. In this case, only knowledge of the zero-crossing, τ_{ZC}, of a Bessel function of order 0 is required to calculate the Doppler frequency. The Bessel function of order 0 has its first zero-crossing at 2.4048, so the Doppler frequency can be estimated from the zero-crossing by

\hat{f}_{d}=2.4048/(2πτ_{ZC}) (4)

### At step 207, the method can end.

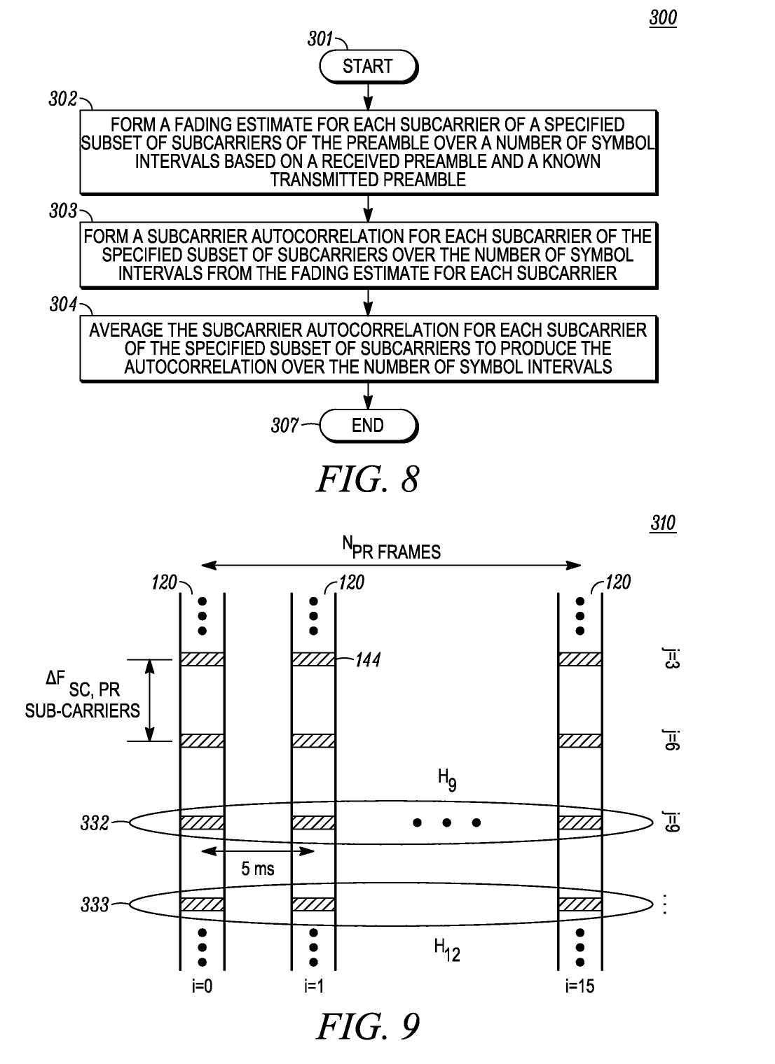

Briefly, the method step 204 for computing the autocorrelation from the preambles and pilots can be achieved by computing a first autocorrelation from the preambles in parallel with computing a second autocorrelation from the pilots. Notably, the method step 204, uses a product of a preamble fading estimate and a pilot fading estimate that is averaged over a plurality of frames that is independent of pilot structure for computing the autocorrelation. A first method 300 for computing a first portion of the autocorrelation from only the preambles is presented in FIG. 8. A second method 400 for computing a second portion of the autocorrelation from the preambles and pilots is presented in FIG. 11.

Referring to FIG. 8, a method 300 for computing the autocorrelation from only the preambles is shown. The method 300 can be practiced with more or less than the number of steps shown. To describe the method 300, reference will be made to FIGS. 2 and 9 although it is understood that the method 300 can be implemented in any other suitable device or system using other suitable components. Moreover, the method 300 is not limited to the order in which the steps are listed in the method 300.

At step 301, the method 300 can start. As an example, in the context of IEEE 802.16 frame parameters and values, a sampling time of 5 ms can be used, which gives a sampling rate of 200 Hz. Accordingly, the maximum Doppler frequency that can be reliably detected is 100 Hz; that is, half the sampling frequency based on the Nyquist theorem. If a carrier frequency of 2.5 GHz for the communication signal is used, a vehicle speed of 41 km/hr using EQ (2) can be determined. Briefly referring to FIG. 9, an illustration of the preambles 120 for multiply received frames is shown. The sampling time of 5 ms corresponds to the frame time interval for each preamble 120. That is, every 5 ms a frame (102) containing a downlink portion (111) is received (See FIG. 2). Only the preamble 120 are shown in FIG. 9, as the method 300 is based only on using information in the preamble 120 to estimate a first autocorrelation, R_{PR}(τ). Note the “PR” in the subscript refers to the use of Preambles only in this method, in contrast to “PI” which will be used in the Preambles-plus-pilots method later. During the Preamble symbol time, a known sequence is transmitted on every third sub-carrier 144, excluding the guard-bands. For an FFT size of 512, this amounts to 143 sub-carriers as illustrated in FIG. 5. To keep complexity and storage low, only a subset of the 143 Preamble sub-carriers will be used. Those used will be spread across the frequency band uniformly, spaced apart by ΔF_{SC,PR} sub-carriers. The lowest value possible for ΔF_{SC,PR} is 3, because every third sub-carrier is used in Preamble transmission. However, much higher values, up to 30, can be used with negligible effect on performance and substantial benefit in complexity and storage. The fading estimates (channel estimates) on the subset of Preamble sub-carriers will be stored over a window of N_{PR} frames. During each frame, an estimate of R_{PR}(τ) will be formed, and the Doppler estimated according to EQ 3 above.

At step 302, a fading estimate can be formed for each subcarrier of a specified subset of subcarriers of the preamble over a number of symbol intervals based on a received preamble and a known transmitted preamble. Briefly, referring to FIG. 9:
a. For the jth sub-carrier (144) of the subset, form the fading estimate

$${H}_{j} ( i ) = \frac{{Y}_{j} ( i )}{{X}_{j} ( i )}$$

where Yⱼ(i) and Xⱼ(i) are the received and transmitted signals, respectively, in the ith symbol interval.
b. Store the current fading estimate, to form a window of N_{PR} fading estimates, spaced apart in time by 5 ms:

[Hⱼ(i−N_{PR}+1),Hⱼ(i−N_{PR}+2), . . . ,Hⱼ(i)]

A fading estimate for each subcarrier can be determined. For example, referring to FIG. 9, fading estimate H₉ 332 corresponds to the fading estimate of subcarrier j=9 calculated over a time span of 80 ms (i.e. i=16 frames×5 ms/frame=80 ms). As another example, the fading estimate H₁₂ 333 corresponds to the fading estimate of subcarrier j=12 calculated over a time span of 80 ms.

At step 303, a subcarrier autocorrelation can be formed for each subcarrier of the specified subset of subcarriers over the number of symbol intervals from the fading estimate for each subcarrier, Hⱼ. Briefly, referring to FIG. 9:
c. For each sub-carrier of the subset, form the auto-correlation R_{PR,j}(τ) from the window in b), for the time values τ=[0,5,10, . . . ,5(N_{PR}−1)] in msec.

At step 304, the subcarrier autocorrelation can be averaged for each subcarrier of the specified subset of subcarriers to produce the autocorrelation over the number of symbol intervals. Briefly, referring to FIG. 9:
d. For each time value τ in [0,5,10, . . . ,5(N_{PR}−1)] msec, average the R_{PR,j}(τ) over the specified subset of sub-carriers to obtain the estimate R_{PR}(τ).
   The autocorrelation R_{PR}(τ) can be used in accordance with method steps 205 and 206 of FIG. 2 for estimating a Doppler frequency. In particular, briefly referring to FIG. 9:
e. Interpolate the first zero-crossing τ_{ZC}, and estimate the Doppler frequency for the frame as \hat{f}_{d}(i)=(2.4048)/(2πτ_{ZC}).
f. If there is no zero-crossing, estimate \hat{f}_{d}(i)=(2.4048)/(2π·5(N_{PR}−1)), where 5 is the time in ms.

### At step 307, the method 300 can end.

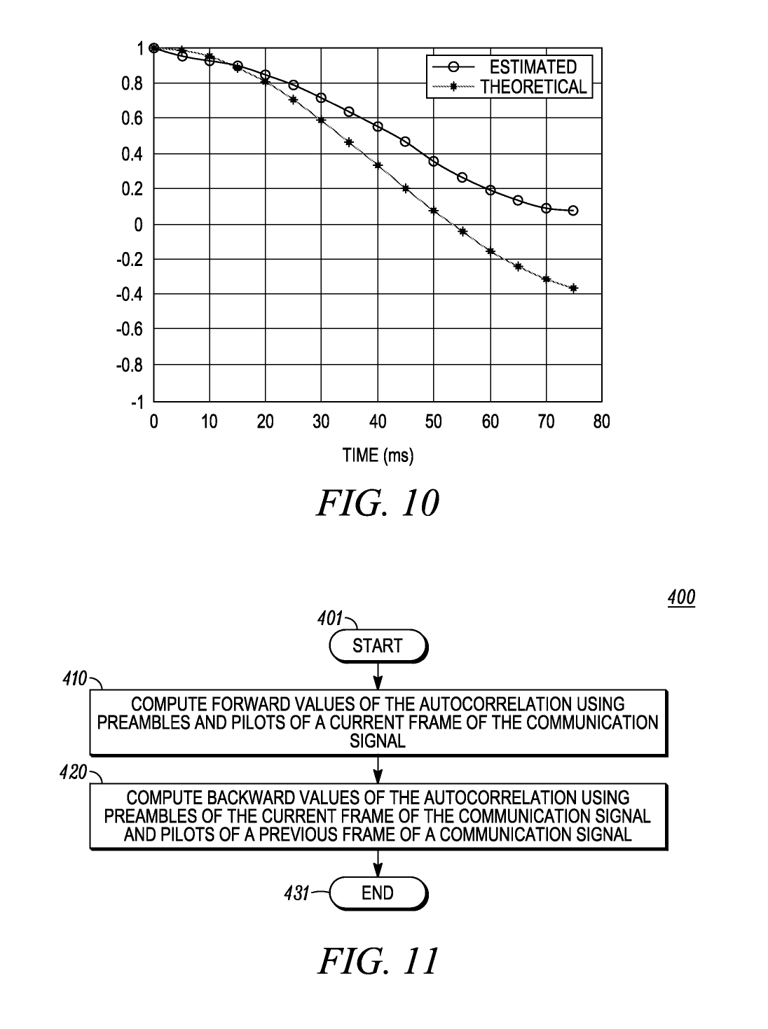

For very low Doppler frequencies, the estimated autocorrelation R_{PR}(τ) might not have a zero-crossing, as shown in FIG. 10, for a speed of 3 km/hr. A good strategy in such cases is to set the estimate to a pre-determined low value. The lowest detectable value occurs when there is a zero-crossing at the edge of the time window, or 5(N_{PR}−1) in this scenario. Notably, the edge of the time window includes a scaling of 5 which corresponds to the time interval of 5 ms used in the example. Understandably, the scaling factor changes in accordance with the time interval. The estimate then becomes

\hat{f}_{d}(i)=(2.4048)/(2π·5(N_{PR}−1)) (5)

In EQ (5), 5 is the time in milliseconds (i.e. 5 ms). Calculating the Doppler frequency from the zero-crossing further comprises estimating the Doppler frequency without the zero-crossing and using instead the number of symbol intervals if the autocorrelation does not cross zero. Accordingly, the preambles method 300 provides a detection of the Doppler frequency to within a first low frequency range. In the foregoing description, a method for using preambles and pilots to compute the autocorrelation is presented for extending the detection of the Doppler frequency to a high frequency range.

Referring to FIG. 11, a method 400 for computing the autocorrelation from the preambles plus pilots is shown. Briefly, the computation of R_{PI}(τ) as shown by method 400 is divided into two parts, for the “forward values” and “backward values.” At step 410, forward values of the autocorrelation can be computed using preambles and pilots of a current frame of the communication signal. At step 420, backward values of the autocorrelation can be computed using preambles of the current frame of the communication signal and pilots of a previous frame of the communication signal. In particular, backward values of the autocorrelation can be computed by determining whether a time interval index of the autocorrelation falls within a forward range corresponding to a downlink portion of a current frame, or whether the time interval index falls within a backward range corresponding to a downlink portion of a previous frame.

As mentioned before, the previous method 300 using Preambles only, in the context of IEEE 802.16 frame parameters and values, is limited to Doppler frequencies less than 100 Hz, corresponding to a speed of 41 km/hr. For estimation of Doppler frequencies above 100 Hz, the sampling rate of the channel is increased by including pilots in the calculation of the autocorrelation. That is, referring back to FIG. 4, the pilots 125 in the Traffic portion of the Downlink 111 Frame must be used. The method 400 applies to the most general case, in which there is no restriction on the number and type of zones used throughout a frame, or in any subsequent frames. For example, the autocorrelation can be computed regardless of where the pilots 125 are dispersed within the downlink traffic portion. Notably, the autocorrelation does not require a uniform spacing to evaluate the correlation between pilots 125. That is, the autocorrelation can be computed from irregularly spaced pilot intervals.

Notably, the auto-correlation R(k) is the expected value of the product of fading estimate samples, H(n), spaced apart by k time intervals:

R(k)=E[H(n)H*(n+k)] (6)

The expected value operator, E, implies that the correlation of the fading estimates, H(n), are averaged over time. The auto-correlation R_{PI}(τ) is computed for time values of [0,ΔS_{PI}Tₛ,2ΔS_{PI}Tₛ. . . ,5] in msec, where ΔS_{PI} is given in symbol intervals and Tₛ is the symbol time. Notably, the timing resolution is increased as a result of shorter sampling intervals. In the preambles only method 300, the preamble spacing occurred at timer intervals of 5 ms. In the preambles and pilots method the pilot spacing occurs at timer intervals smaller than 5 ms. Accordingly, a higher Doppler frequency can be determined due to the increased sampling of the channel.

The “PI” in the subscript refers to the fact that pilots are used, in contrast to the Preambles-only method in which “PR” is used. The purpose of introducing the parameter ΔS_{PI} is to trade off computation versus maximum detectable Doppler frequency. If the autocorrelation R_{PI}(τ) were computed with a spacing of one symbol, or 100 us, the sampling frequency would be 10 kHz, meaning that Doppler frequencies up to 5 kHz could be detected. That range corresponds to an extraordinarily high speed which is not common for passenger traffic vehicles. Accordingly, the symbol spacing for computing the autocorrelation can be realized by setting the value to 4 to achieve significant savings in computation and storage. Notably, the value is not limited to 4, and any value can be chosen to correspond to an anticipated speed.

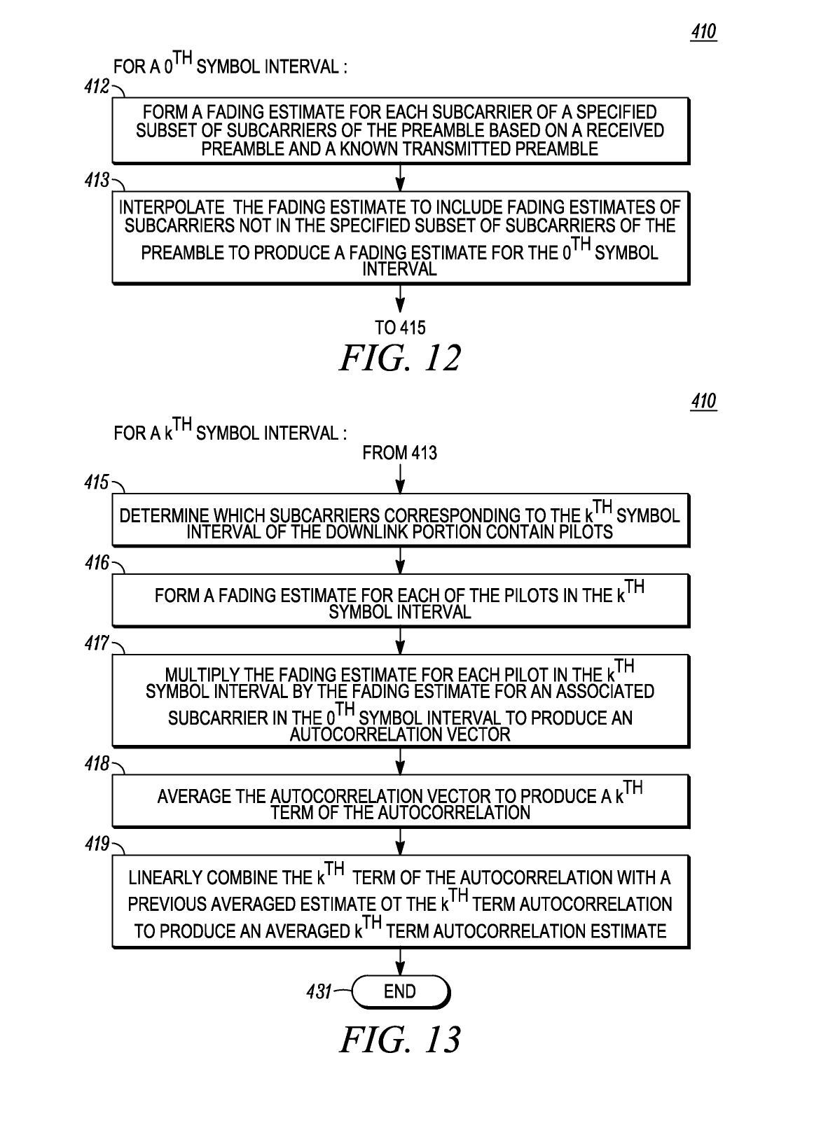

Referring to FIG. 12, the method 410 for computing the forward values of the autocorrelation from the preambles and pilots is shown in greater detail. Briefly, the forward values correspond to the time indices on τε(0, N_{DL}Tₛ), where N_{DL} is the number of symbols in the Downlink portion of the frame. Briefly, the method steps 412 and 413 use the preamble 120 of the downlink 111 portion (See FIG. 9). The preamble 120 corresponds to the 0^{th} symbol interval. The method steps 412 and 413 also correspond similarly in function to the method steps 302 and 303 of FIG. 8, respectively.

At step 412, a fading estimate can be formed for each subcarrier of a specified subset of subcarriers of the preamble based on a received preamble and a known transmitted preamble. For example, referring back to FIG. 9, fading estimate H₉ 332 corresponds to the fading estimate of subcarrier j=9 calculated over a time span of 80 ms (i.e. i=16 frames×5 ms/frame=80 ms). As another example, the fading estimate H₁₂ 333 corresponds to the fading estimate of subcarrier j=12 calculated over a time span of 80 ms.

At step 413, the fading estimate Hⱼ can be interpolated to include fading estimates of subcarriers not in the specified subset of subcarriers of the preamble to produce a fading estimate for the 0^{th} symbol interval. Notably the fading estimate for the 0^{th} symbol interval corresponds to the preamble 120.

Method step 412 and 413 can be summarized as follows:
1) Form the fading estimate on the Preamble sub-carriers of the ith frame, and interpolate to obtain fading estimates on all sub-carriers of the Preamble (excluding the guard bands).

Referring to FIG. 13, the method 410 is continued for the k^{th} symbol interval. At step 415, subcarriers corresponding to the k^{th} symbol interval of the downlink portion contain pilots can be determined. For example, as previously presented, the processor 131 (See FIG. 5) can identify locations of the pilots in the downlink portion from the control header 119 (See FIG. 4). The pilots may be arranged in specific locations based on a pilot structure associated with each zone.

At step 416, a fading estimate can be formed for each of the pilots in the k^{th} symbol interval. The fading estimates for the pilots can be formed using a methodology similar to the fading estimates for the preambles

Method step 415 and 416 can be summarized as follows:
2) For the kth symbol interval (the Preamble is assumed to be the 0^{th} symbol interval), determine the sub-carriers on which pilots are transmitted and form their fading estimates. The location of pilots for a particular symbol depends on the zone type and the cell/sector.

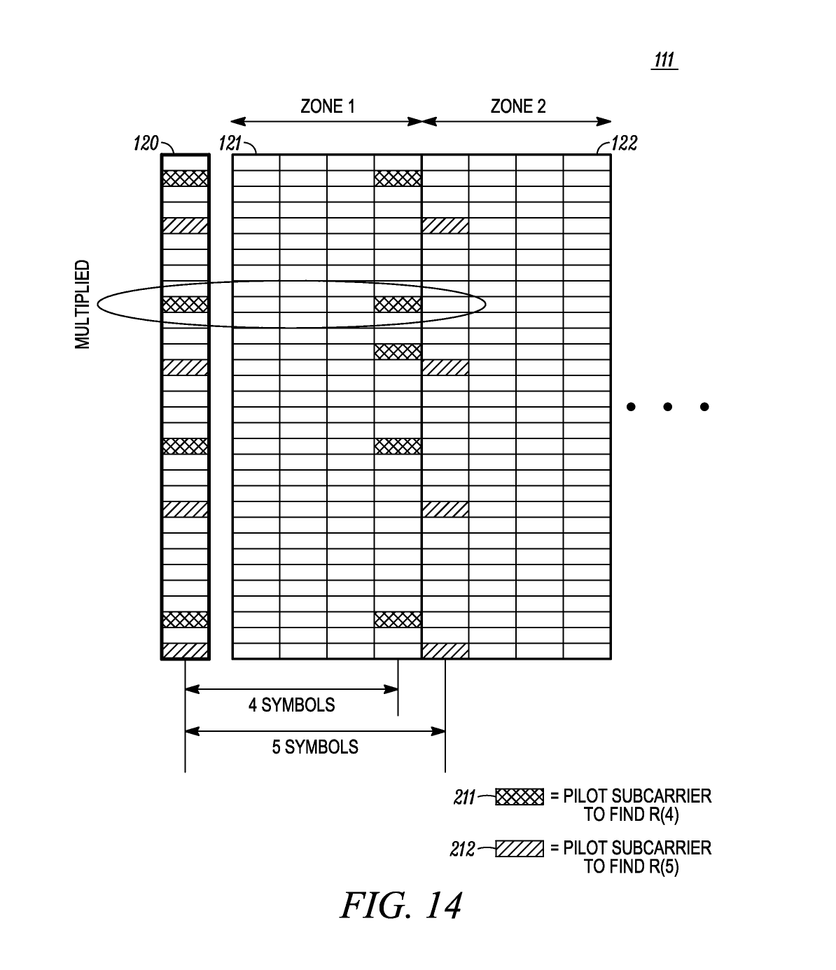

At step 417 of FIG. 14, the fading estimate for each pilot in the k^{th} symbol interval can be multiplied by the fading estimate for an associated subcarrier in the 0^{th} symbol interval to produce an autocorrelation vector corresponding to the k^{th} symbol interval. For illustration, referring to FIG. 14, an autocorrelation value can be computed for each subcarrier based on a location of the pilot. Moreover, the autocorrelation references the preamble 120 for calculating the autocorrelation value. For example, calculating R(4) entails identifying pilots 211 spaced 4 lags from the preamble 120. Each of the pilots 211 is identified, and a contribution to the autocorrelation is formed. That is, each pilot 211 is multiplied by the associated 0^{th} symbol in the subcarrier of the preamble 120. An autocorrelation vector is formed by multiplying each of the pilots with the corresponding symbol in the subcarrier. Similarly, the autocorrelation value R(5) can be calculated using pilots spaced at 5 lags from the preamble 120. Each of the pilots identified 5 lags away from the preamble can be multiplied by the symbol of the associated subcarrier in the preamble. The multiplication operation corresponds to the correlation of the fading estimate for the associated lag term, k, in EQ (3).

At step 418, the autocorrelation vector can be averaged to produce a k^{th} term of the autocorrelation. Accordingly, the k^{th} term provides one value of the autocorrelation. Upon completing k symbol intervals, a current-frame autocorrelation from the k terms of the autocorrelation is formed.

Method step 417 and 418 can be summarized as follows:
3) From the Preamble, retrieve the fading estimates on those same sub-carriers for the 0^{th} symbol interval.
4) Form a current-frame estimate of R_{PI}(k·ΔS_{PI}Tₛ) using EQ (6). For example, if there are 20 pilots in the kth interval, form the 20 products and take the average.

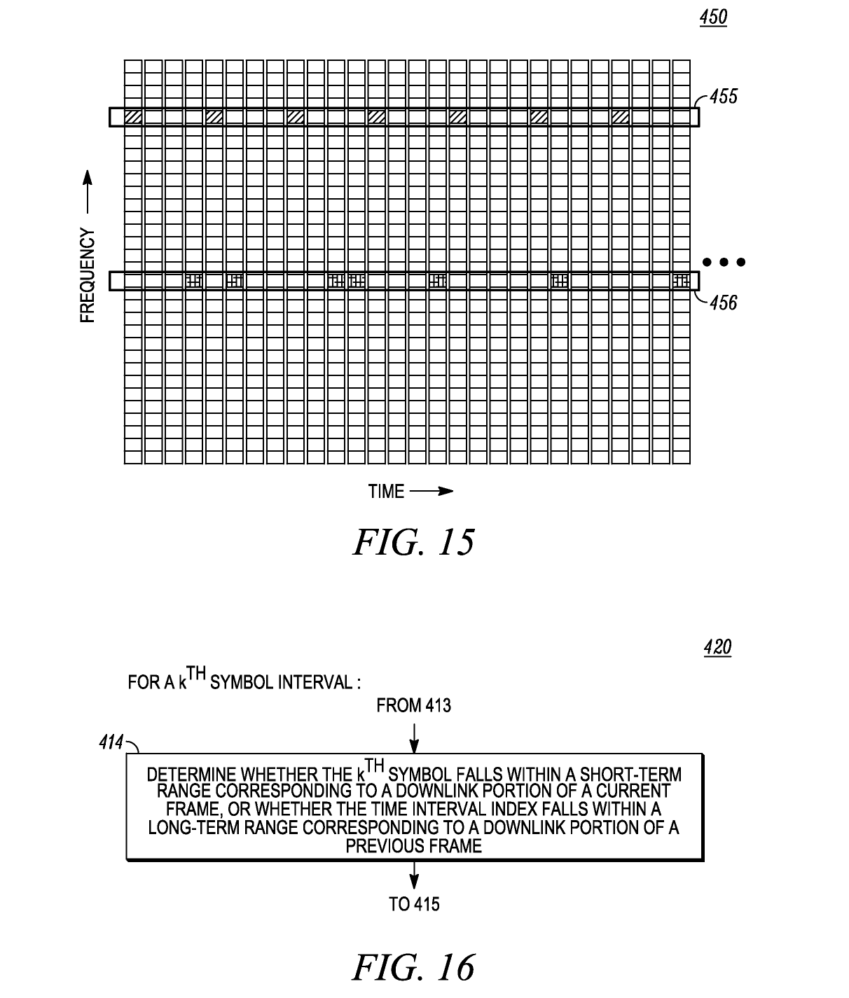

Briefly, the method steps 417 and 418 uniquely define a means for calculating an autocorrelation sequence when uniform pilot spacing is unavailable. Moreover, even if the pilots are uniformly spaced, computational savings can be gained by the particular implementation of the autocorrelation. In particular, the autocorrelation values are calculated one at a time over a time interval for realizing the expectation operator, E, of EQ (3). That is, the values of the autocorrelation are averaged individually over time for generating the expectation operator, versus averaging the entire autocorrelation over time. For example, referring to FIG. 15, a comparison 450 of calculating the autocorrelation using uniform pilot spacing versus irregularly pilot spacing is shown. In particular, the pilot spacing for subcarrier 455 allows for the calculation of a direct autocorrelation. That is, the pilots are uniformly spaced such that the convolution operator of the fading estimates in EQ (3) allows for an aligned point wise multiplication. In contrast, the pilot spacing for subcarrier 456 is irregular, such that the convolution operation of the fading estimates in EQ (3) do not allow for an alignment of fading estimates when shifted.

First, if the pilots on the top sub-carrier 455 only are collected, the result is a sequence of fading estimates, uniformly spaced 4 symbol intervals apart, [H(0),H(4Tₛ),H(8Tₛ), . . . ,H(32Tₛ)]. A standard autocorrelation computation, with a sliding window or with FFT's, can give an estimate of R_{PI}(τ) at time intervals τ=(0,4Tₛ,8Tₛ, . . . ,32Tₛ), i.e. with a sampling rate of 4Tₛ. However, the sampling rate of R_{PI}(τ) cannot just be changed arbitrarily to 3Tₛ or 5Tₛ, for example. So even for uniformly spaced pilots, existing techniques are constrained in the possible sampling rates for R_{PI}(τ).

Second, consider the bottom sub-carrier, in which the pilots are irregularly spaced. The fading estimates on that sub-carrier are [H(3Tₛ),H(5Tₛ),H(10Tₛ),H(11Tₛ),H(15Tₛ),H(21Tₛ),H(30Tₛ)]. From this sequence alone, it is not possible to get any autocorrelation estimates using the standard autocorrelation computations.

At step 419, the k^{th} term of the autocorrelation can be combined with a previous averaged estimate of the k^{th} term autocorrelation to produce an averaged k^{th} term autocorrelation estimate. The combining gives each k^{th} symbol interval a weighting in the current-frame autocorrelation. At step 431, the method 410 can end. It should be noted that the method 400 can compute the autocorrelation for any sampling rate that is a multiple of Tₛ, and for any arrangement of pilot locations. Moreover, the method 400 can apply to a broader class of OFDM-based protocols having reference Preamble symbols.

Referring to FIG. 16, the method 420 for computing the backward values of the autocorrelation from the preambles and pilots is shown in greater detail. Briefly, the backward values correspond to the time indices on τε(N_{DL}Tₛ,5), where N_{DL} is the number of symbols in the Downlink portion of the frame. The method 420 can continue from method step 413 of FIG. 12 and return to method step 415 of FIG. 13 Notably, the method 420 for computing backward values includes one additional step 414 not included in method 410. In particular, the method step 414 determines whether the k^{th} symbol falls within a forward range corresponding to a downlink portion of a current frame, or whether the k^{th} symbol falls within a backward range corresponding to a downlink portion of a previous frame. That is the method step 414 determines whether pilots of the current frame are used in calculating the fading estimate, or whether pilots of a previous frame are used in calculating the fading estimate. It should be noted that, detection of the Doppler frequency within a higher frequency range requires a higher sampling rate of the channel. However, there may be insufficient pilots in the current frame to provide the increased sampling rate. Accordingly, pilots from previous frames are stored and evaluated to provide contribution to the current fading estimate.

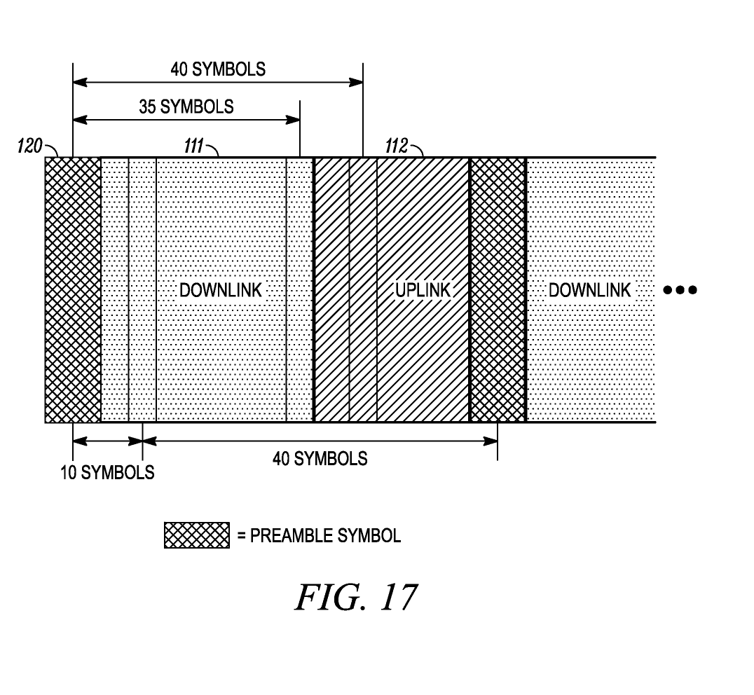

Briefly, the method 410 of computing the forward values gives values of R_{PI}(τ) for time values in the range τε(0,N_{DL}Tₛ). As illustrated in FIG. 17, the method 410 cannot give values of R_{PI}(τ) for time values greater than N_{DL}Tₛ, because those time separations beyond the Preamble 120 fall in the Uplink 112 portion. However, those time separations can be achieved between the current Preamble 120 and pilots in the previous frame, which will fall in the Downlink portion of the previous frame. Therefore, time values above N_{DL}Tₛ are called “backward values”.

The method 420 for calculating the backward values, including continuing method steps 415-419 of method 410, is as follows:
1) Form the fading estimate on the Preamble sub-carriers of the ith frame, and interpolate to obtain fading estimates on all sub-carriers of the Preamble (excluding the guard bands). Note: this step is already performed above in the first part, for the forward values.
2) For each k such that k·ΔS_{PI}Tₛ is within the range (N_{DL}Tₛ,5), determine the appropriate symbol interval in the previous frame which gives the intended separation of k·ΔS_{PI}Tₛ between itself and the current Preamble. For example in FIG. 10, with a Downlink/Uplink split of 70/30 and guard intervals not shown, there are 35 Downlink and 15 Uplink symbols. To compute R_{PI}(40Tₛ), the 10^{th} symbol interval of the previous frame and the current Preamble can be used, because they are spaced 40 symbol intervals apart.
3) For the symbol interval, determine the sub-carriers on which pilots are transmitted and collect their fading estimates. The location of pilots for a particular symbol depends on the zone type and the cell/sector.
4) From the Preamble, retrieve the fading estimates on those same sub-carriers for the 0^{th} symbol interval.
5) Form a current-frame estimate of R_{PI}(k·ΔS_{PI}Tₛ) using EQ (6). For example, if there are 20 pilots in the symbol interval, form the 20 products and take the average.
6) Combine the current-frame estimate of R_{PI}(k·ΔS_{PI}Tₛ) with the previous averaged estimate to give the new averaged estimate, in a manner that gives each interval equal weighting. For example, if this is the 6^{th} frame, the old long term estimate has a weighting of ⅚ and the current short-term estimate has a weighting of ⅙. The current-frame autocorrelation estimates will be stored for each frame in a window of N_{Pi} frames.
7) Repeat 3-6 for each value of k, storing the current frame estimates of R_{PI}(k·ΔS_{PI}Tₛ).

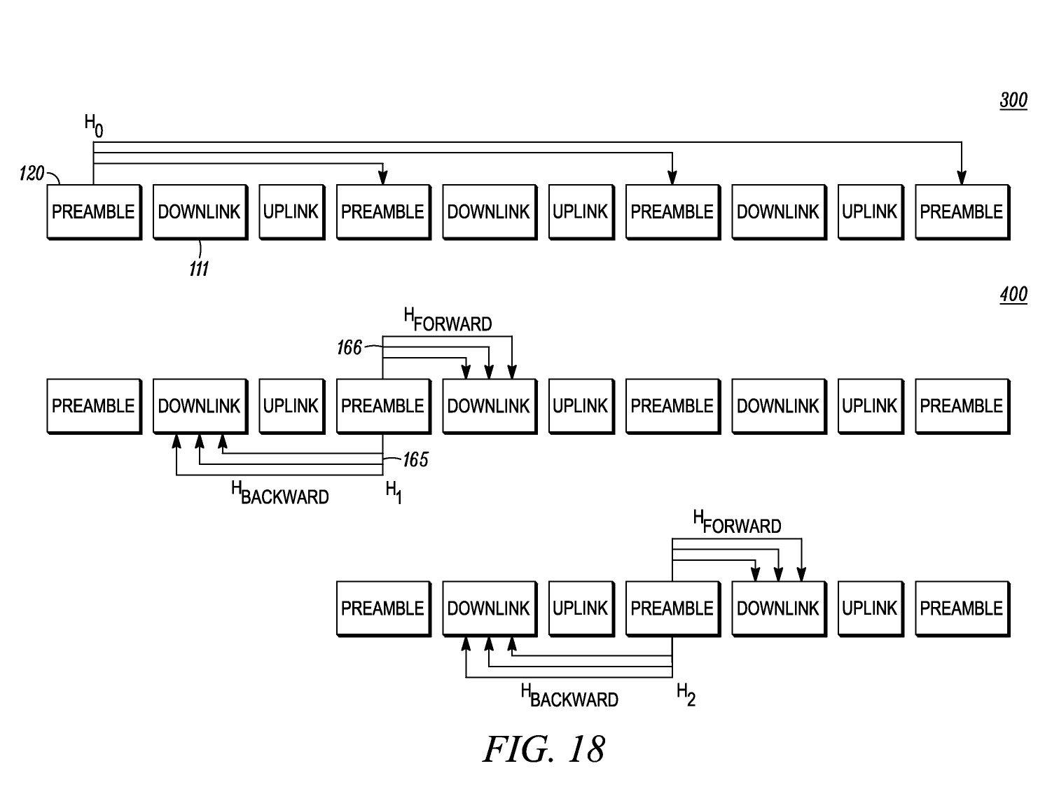

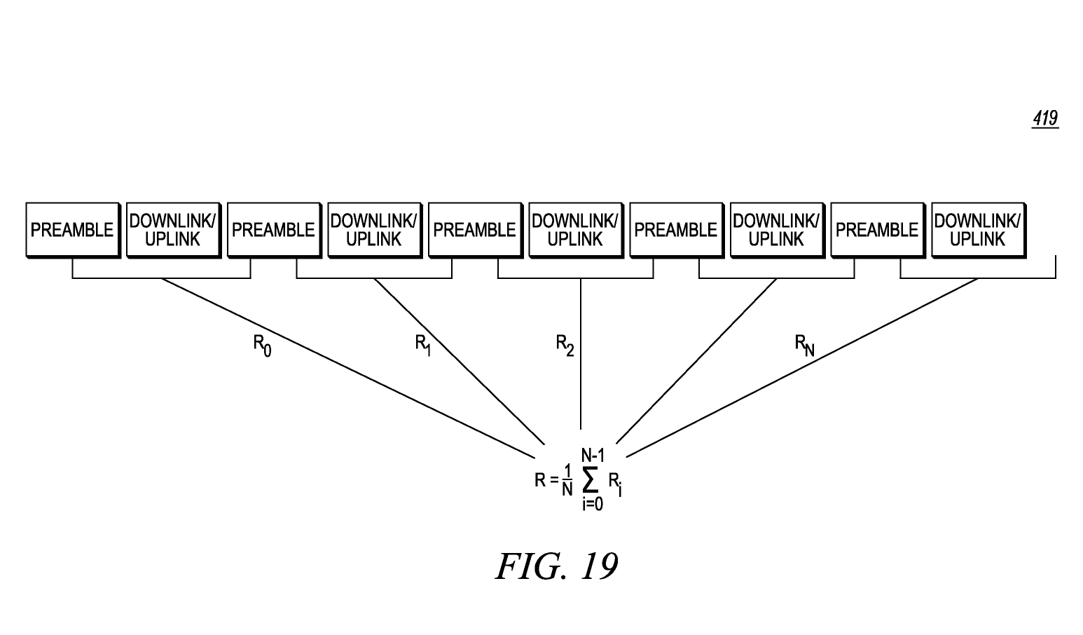

Referring to FIG. 18, an exemplary illustration for computing the preambles and pilots is shown. For example, the fading estimate H₀ using the preambles only method 300 uses only frame preambles 120. In contrast, the fading estimate for the preambles-plus-pilots method 400 employs both forward values of the fading estimates H_{forward} 166 and backward values of the fading estimates H_{backward} 165. The forward 166 and backward 165 fading estimates are used to compute the autocorrelation as previously described in methods 410 and 420. Notably, the resulting autocorrelation, which is a function of the fading estimates as described in EQ (3) is a combination of autocorrelation values from current and previous frames averaged over time. For example, referring to FIG. 19, it can be seen that the autocorrelation R is a combination of autocorrelations R₀, R₁, . . . R₁₅ averaged over multiple frames.

The estimation of the Doppler frequency using preambles and pilots as described in method 300 and 400, can be summarized as follows:
a. Compute forward values of R_{PI}(τ).
b. Compute backward values of R_{PI}(τ).
c. Interpolate first zero-crossing τ_{ZC} of R_{PI}(τ).
d. If there is a zero-crossing, estimate the Doppler frequency as \hat{f}_{d}(i)=(2.4048)/(2πτ_{ZC})
e. If there is not a zero-crossing, the Doppler frequency is too low for this algorithm, so perform Preambles-only Doppler estimation.
   In the context of the TDD mode of IEEE 802.16, recall that the autocorrelation R_{PI}(τ) is only calculated up to 5 ms. Therefore, the lowest Doppler frequency that can be detected occurs when there is a zero-crossing at 5 ms, or (2.4048)/(2π·0.005)=76.5 Hz. The Preambles-plus-pilots method can run in parallel with the Preambles-only method. If the Doppler frequency is low, R_{PI}(τ) will not have a zero-crossing, but R_{PR}(τ) probably will have one, and we use the zero-crossing of R_{PR}(τ) to estimate the Doppler frequency. On the other hand, if the Doppler frequency is high, R_{PI}(τ) will have a zero-crossing, and can be used to determine the Doppler frequency.

One of the innovative aspects of preambles and pilots method 400 is that zone switches can be handled without complication. For example, each calculation R_{PI}(k) involves correlating a Preamble fading estimate with a traffic fading estimate, but not two traffic fading estimates. For example, referring back to FIG. 14, the pilot locations for the 4th and 5th symbol are shown. Because a zone switch takes place after the 4th symbol, the pilot locations are different in the two intervals. The computation of R_{PI}(4) is performed using the fading estimates from the pilots in the 4th interval and the fading estimates on the same sub-carriers of the Preamble. Although the pilots in the 5th interval are different from those in the 4th interval, there is no problem in computing R_{PI}(5) because the Preamble also contains fading estimates on those sub-carriers.

On the other hand, consider using the 4th and 5th symbol intervals to help compute R_{PI}(1), which is possible because they are spaced one interval apart. However, the situation becomes very complicated when zone switches take place, because the 4th and 5th intervals have pilots in different locations. And a windowed autocorrelation per sub-carrier also would not work if there is a zone switch as previously explained in the discussion of FIG. 15.

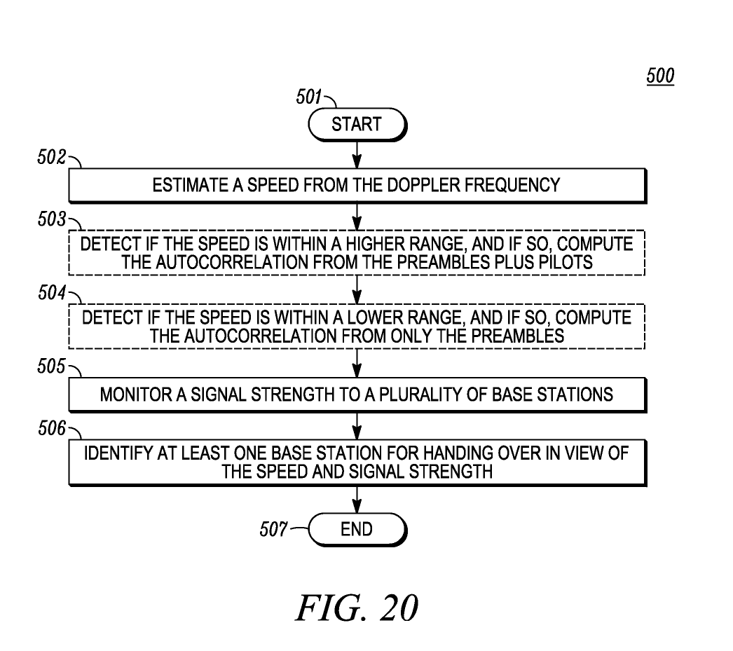

It should be noted that the Doppler frequency can be used for various applications such as estimating the speed of a vehicle or updating fading channel estimates. For example, fading channel estimates can be updated in accordance with the speed to ensure reliable coverage and account for varying channel conditions due to movement. Referring to FIG. 20, a method 500 for estimating a speed of a vehicle is shown. It should be noted that the method 500 is merely one example of using the Doppler frequency to accomplish a function. Many other uses of the Doppler frequency are herein contemplated. Accordingly, embodiments of the invention are not limited to using the Doppler frequency to only updating hand-offs. The method 500 can start at 501.

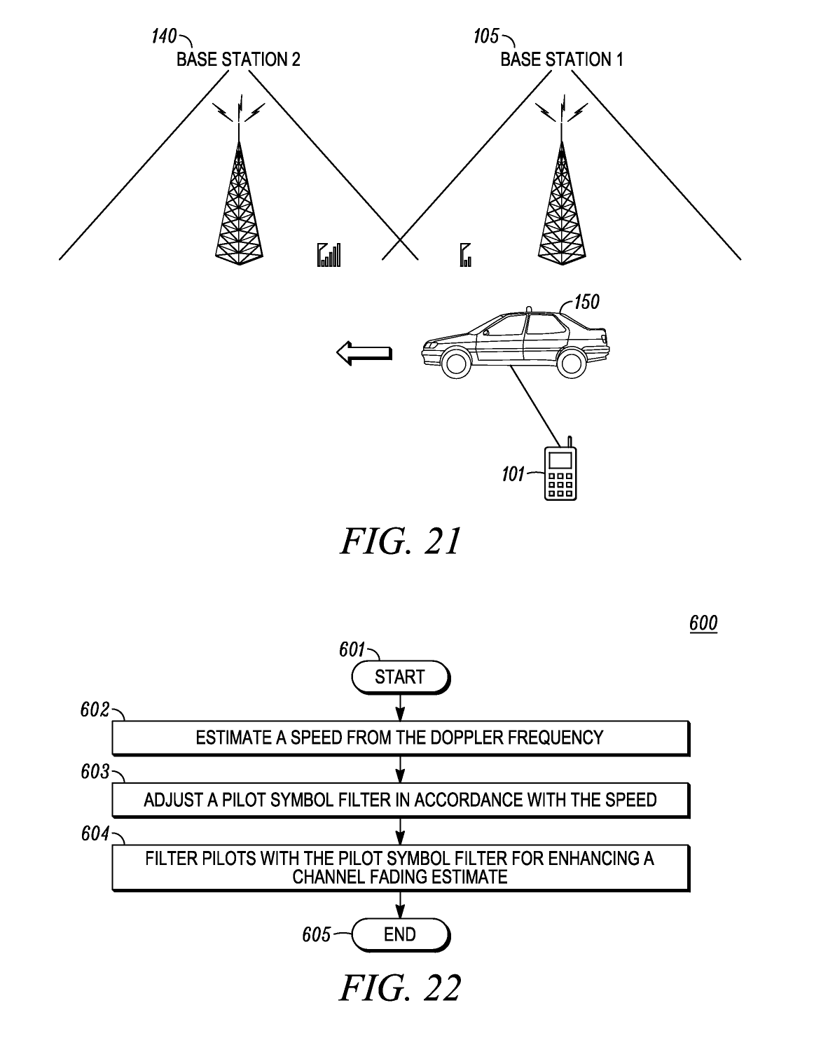

At step 502, a speed from the Doppler frequency can be estimated. For example, referring to FIG. 21, the mobile device 101 may be in a moving vehicle 150, and in communication with a base station 105. Referring to FIG. 5, the processor 131 can estimate the Doppler frequency in accordance with the method 300 and 400, as previously explained. In particular, at step 503, the processor can first compute the autocorrelation from the preambles and pilots, and determine if a zero-crossing exists in the autocorrelation thus indicating a high Doppler frequency. If a zero-crossing exists, a speed can be estimated from the high Doppler frequency. Else, at step 504, the processor can compute the autocorrelation from only the preambles, and determine if a zero-crossing exists thus indicating a low Doppler frequency. If a zero-crossing exists, the speed can be estimated from the low Doppler frequency. Else, the Doppler frequency can be estimated from a frame interval, and the speed then estimated from the Doppler frequency.

At step 505, a signal strength received from a plurality of base stations can be monitored. For example, referring to FIG. 21, the mobile device 101 can evaluate a signal strength to one or more base stations (105 and 140). As the vehicle moves, the signal strength to the mobile device may vary. Moreover, the signal to noise ratio may decrease as the mobile device moves away from a base station. The monitoring can be performed in accordance with the speed. For example, the rate of signal strength estimates calculated can be increased as the detected speed increases. That is, a rate of signal strength estimation can be increased to one or more base stations in accordance with the speed. In this manner, channel conditions can be assessed and accounted for more often if the vehicle 150 travels at a higher speed. As an example, in the process of channel equalization, received pilot symbol estimates are generally noisy. The noise on the pilot symbols may be reduced by averaging or filtering in the time domain. The length of the appropriate filtering window may be determined using the Doppler estimate. As the user velocity is increased, the pilot symbol filtering window length is reduced. As the user velocity decreases, the pilot symbol filtering window length is increased.

At step 506, at least one base station can be identified for handing over in view of the speed and signal strength. For example, referring to FIG. 20, the mobile device 101 may detect an increase in signal strength to base station 140. At step 507, the method 500 can end.

As another example, referring to FIG. 22, a method using the Doppler frequency estimation is shown for noise reduction in channel estimation. Briefly, in the process of channel equalization, received pilot symbol estimates are generally noisy. The noise on the pilot symbols may be reduced by averaging or filtering in the time domain. The length of the appropriate filtering window may be determined using the Doppler estimate. As the user velocity is increased, the pilot symbol filtering window length is reduced. As the user velocity decreases, the pilot symbol filtering window length is increased.

Accordingly, at step 601, the method can start. At step 602, a speed can be estimated from the Doppler frequency. At step 603, a pilot symbol can be adjusted in accordance with the speed. At step 604, the pilots can be filtered with the pilot symbol filter to enhance a channel fading estimate by reducing noise on the pilots.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A method for estimating a Doppler frequency, comprising:
receiving a communication signal containing preambles and pilots;
computing an autocorrelation from the preambles and pilots;
identifying a zero-crossing of the autocorrelation; and
calculating the Doppler frequency from the zero-crossing, wherein the autocorrelation uses a product of a preamble fading estimate and a pilot fading estimate that is averaged over a plurality of frames that is independent of pilot structure.

2. The method of claim 1, further comprising:
identifying a changing location of the pilots within a received downlink portion of a frame,
wherein the communication signal includes at least a preamble portion and a downlink portion, and the pilots are located in irregularly spaced intervals in at least one zone in the downlink portion.

3. The method of claim 1, wherein computing the autocorrelation from only the preambles provides a low frequency range for detecting the Doppler frequency, and computing the autocorrelation from the preambles and the pilots provides a high frequency range for detecting the Doppler frequency.

4. The method of claim 1, further comprising:
computing the autocorrelation from the preambles and pilots, and determining if a zero-crossing exists in the autocorrelation thus indicating a high Doppler frequency,
if a zero-crossing exists,
estimating a speed from the high Doppler frequency, else,
computing the autocorrelation from only the preambles, and determining if a zero-crossing exists thus indicating a low Doppler frequency,
if a zero-crossing exists,
estimating the speed from the low Doppler frequency, else,
estimating the Doppler frequency from a frame interval; and
estimating the speed from the Doppler frequency.

5. The method of claim 2, wherein the receiving a communication signal further comprises:
decoding a control information header in the communication signal; and
determining a location of the pilots in the irregularly spaced intervals in the at least one zone of the downlink portion from the control information header,
wherein the downlink portion includes the at least one zone having an irregular pilot structure.

6. The method of claim 1, wherein computing an autocorrelation from the preambles includes:
forming a fading estimate for each subcarrier of a specified subset of subcarriers of the preamble over a number of symbol intervals based on a received preamble and a known transmitted preamble;
forming a subcarrier autocorrelation for each subcarrier of the specified subset of subcarriers over the number of symbol intervals from the fading estimate for each subcarrier;
averaging the subcarrier autocorrelation for each subcarrier of the specified subset of subcarriers to produce the autocorrelation over the number of symbol intervals; and
wherein a zero-crossing of the autocorrelation identifies the Doppler frequency.

7. The method of claim 6, wherein calculating the Doppler frequency from the zero-crossing further comprises:
estimating the Doppler frequency without the zero-crossing and using instead the number of symbol intervals if the autocorrelation does not cross zero.

8. The method of claim 1, wherein computing an autocorrelation from the preambles and pilots includes:
computing forward values of the autocorrelation using preambles and pilots of a current frame of the communication signal; and
computing backward values of the autocorrelation using preambles of the current frame of the communication signal and pilots of a previous frame of the communication signal,
wherein computing backward values of the autocorrelation includes determining whether a time interval index of the autocorrelation falls within a forward range corresponding to a downlink portion of a current frame, or whether the time interval index falls within a backward range corresponding to a downlink portion of a previous frame.

9. The method of claim 8, wherein computing forward values of the autocorrelation includes:
for a 0^{th} symbol interval,
forming a fading estimate for each subcarrier of a specified subset of subcarriers of the preamble based on a received preamble and a known transmitted preamble;
interpolating the fading estimate to include fading estimates of subcarriers not in the specified subset of subcarriers of the preamble to produce a fading estimate for the 0^{th} symbol interval,
for a k^{th} symbol interval,
determining which subcarriers corresponding to the k^{th} symbol interval of the downlink portion contain pilots;
forming a fading estimate for each of the pilots in the k^{th} symbol interval;
multiplying the fading estimate for each pilot in the k^{th} symbol interval by the fading estimate for an associated subcarrier in the 0^{th} symbol interval to produce an autocorrelation vector corresponding to the k^{th} symbol interval; and
averaging the autocorrelation vector to produce a k^{th} term of the autocorrelation,
wherein, upon completing k symbol intervals, a current-frame autocorrelation from the k terms of the autocorrelation is formed.

10. The method of claim 9, further comprising:
combining the k^{th} term of the autocorrelation with a previous averaged estimate of the k^{th} term autocorrelation to produce an averaged k^{th} term autocorrelation estimate,
wherein the combining gives each k^{th} symbol interval a weighting in the current-frame autocorrelation.

11. The method of claim 10, wherein computing backward values of the autocorrelation includes:
for a 0^{th} symbol interval,
forming a fading estimate for each subcarrier of a specified subset of subcarriers of the preamble based on a received preamble and a known transmitted preamble;
interpolating the fading estimate to include fading estimates of subcarriers not in the specified subset of subcarriers of the preamble to produce a fading estimate for the 0^{th} symbol interval,
for a k^{th} symbol interval,
determining whether the k^{th} symbol falls within a forward range corresponding to a downlink portion of a current frame, or whether the k^{th} symbol falls within a backward range corresponding to a downlink portion of a previous frame,
determining which subcarriers corresponding to the k^{th} symbol interval of the downlink portion contain pilots, and
forming a fading estimate for each of the pilots in the k^{th} symbol interval.
multiplying the fading estimate for each pilot in the k^{th} symbol interval by the fading estimate for an associated subcarrier in the 0^{th} symbol interval to produce an autocorrelation vector corresponding to the k^{th} symbol interval; and
averaging the autocorrelation vector to produce a k^{th} term of the autocorrelation,
wherein, upon completing K symbol intervals, a current-frame autocorrelation from the K terms of the autocorrelation is formed.

12. The method of claim 1, further comprising:
estimating a speed from the Doppler frequency;
adjusting a pilot symbol filter in accordance with the speed; and
filtering pilots with the pilot symbol filter for enhancing a channel fading estimate,
wherein a filter length of the filter is increased as the speed increases, and the filter length is decreased as the speed decreases.

13. A mobile device for estimating a Doppler frequency, comprising:
a transceiver for
receiving a communication signal containing preambles and pilots; a processor for
estimating a channel fading from the preambles and pilots computing an autocorrelation using the channel fading;
identifying a zero-crossing of the autocorrelation; and
calculating the Doppler frequency from the zero-crossing,
wherein the autocorrelation uses a product of a preamble fading estimate and a pilot fading estimate that is averaged over a plurality of communication signals to allow zone independent Doppler frequency estimation.

14. The mobile device of claim 13, wherein the processor:
computes forward values of the autocorrelation using preambles and pilots of a current frame of the communication signal; and
computes backward values of the autocorrelation using preambles of the current frame of the communication signal and pilots of a previous frame of the communication signal,
wherein computing backward values of the autocorrelation includes determining whether a time interval index of the autocorrelation falls within a forward range corresponding to a downlink portion of a current frame, or whether the time interval index falls within a backward range corresponding to a downlink portion of a previous frame.

15. The mobile device of claim 13, wherein estimating a channel fading includes:
identifying a changing location of the pilots in at least one zone of a downlink portion on a frame-by-frame basis,
wherein the communication signal includes at least a preamble portion and a downlink portion, and the pilots are located in irregularly spaced intervals in at least one zone in the downlink portion.

16. The mobile device of claim 13, further comprising:
a controller for
estimating a speed of the mobile device from the Doppler frequency;
detecting if the speed is within a lower range, and if so, computing the autocorrelation from only the preambles; and
detecting if the speed is within a higher range, and if so, computing the autocorrelation from the preambles and pilots.

17. A method for hand-off of a mobile device, comprising:
receiving a communication signal containing preambles and pilots;
computing an autocorrelation from the preambles and pilots;
determining a Doppler frequency from the autocorrelation;
estimating a speed of the mobile device based on the Doppler frequency; and
monitoring a hand-off of the mobile device to one or more base stations based on the speed,
wherein the communication signal includes at least a preamble portion and a downlink portion, and the pilots are in irregularly spaced intervals in at least one zone in the downlink portion.

18. The method of claim 17, further comprising:
detecting if the speed is within a lower range, and if so, computing the autocorrelation from only the preambles;
detecting if the speed is within a higher range, and if so, computing the autocorrelation from the preambles and pilots; and
increasing a rate of signal strength estimation to one or more base stations in accordance with the speed.
wherein the monitoring identifies a signal strength from at least one base station to the mobile device for handing over in view of the speed.

19. The method of claim 18, wherein computing the autocorrelation from the preambles and pilots further comprises:
computing forward values of the autocorrelation using preambles and pilots of a current frame of the communication signal; and
computing backward values of the autocorrelation using preambles of the current frame of the communication signal and pilots of a previous frame of the communication signal,
wherein computing backward values of the autocorrelation includes determining whether a time interval index of the autocorrelation falls within a forward range corresponding to a downlink portion of a current frame, or whether the time interval index falls within a backward range corresponding to a downlink portion of a previous frame.

20. The method of claim 17, wherein the communication signal is transmitted using an OFDM modulation on a Time-Division Duplex (TDD) mode of IEEE802.16e.
